(19) United States
(12) Patent Application Publication
(10) Pub. No.: US 2026/0065397 A1
(43) Pub. Date: Mar. 5, 2026

(54) SALES TRAINING AND RECRUITMENT UTILITY WITH AN AUTODIALER

(71) Applicant: Blink Voice Inc., Uniondale, NY (US)

(72) Inventors: Filippo Justice Bellia, Saint James, NY (US); Justin Joseph Euliano, Northport, NY (US)

(21) Appl. No.: 19/078,926

(22) Filed: Mar. 13, 2025

Related U.S. Application Data
(63) Continuation-in-part of application No. 18/819,913, filed on Aug. 29, 2024.

(51) Int. Cl. G06Q 50/20; H04M 3/51

(52) U.S. Cl. CPC G06Q 50/20; H04M 3/51

(57) ABSTRACT

Described herein are examples of a sales training and recruitment utility with an autodialer configured to record, display, and analyze sales pitches and pitch battles between contestants. Further, the autodialer is configured to operate with the utility as a standalone system separate from a dedicated call center. The sales training and recruitment utility with an autodialer can assist with training sale personal and identifying sales personnel for particular industry and/or expertise level. The sales training and recruitment utility with an autodialer can provide an interactive experience for users as well as training and recruitment benefits for employers.

### CROSS-REFERENCES

This application is a continuation-in-part of U.S. patent application Ser. No. 18/819,913 for “SALES TRAINING AND RECRUITMENT UTILITY” filed on Aug. 29, 2024.

### BACKGROUND

Training systems have been used to educate and instruct sales personnel. Often the training systems include classroom style lectures or rote memorization techniques in which scripts are assigned to individuals. The scripts are designed to maximize sales based on prior analytical data collection. Many existing teaching methods rely on decade old methodology and sales techniques dating back to the door-to-door salesman. Autodialing systems have been available for automatic out-bound calling. The known autodialing systems are generally limited to selecting numbers from predetermined list and auto populating the phone numbers.

### BRIEF DESCRIPTION OF THE DRAWINGS

The present description will be understood more fully when viewed in conjunction with the accompanying drawings of various examples of the sales training and recruitment utility with an autodialer. The description is not meant to limit the sales training and recruitment utility with an autodialer to the specific examples. Rather, the specific examples depicted and described are provided for explanation and understanding of the sales training and recruitment utility with an autodialer. Throughout the description the drawings may be referred to as drawings, figures, and/or FIGS.

FIG. 1 illustrates a sales training and recruitment utility, according to an embodiment.

FIG. 2 illustrates a device schematic for various devices used in the sales training and recruitment utility, according to an embodiment.

FIG. 3 illustrates a Home graphical user interface, according to an embodiment.

FIG. 4 illustrates a Biographical (BIO) graphical user interface, according to an embodiment.

FIG. 5 illustrates a Retrieve Password graphical user interface, according to an embodiment.

FIG. 6 illustrates a Profile graphical user interface, according to an embodiment.

FIG. 7 illustrates a Profile Full Screen graphical user interface, according to an embodiment.

FIG. 8 illustrates a Record Pitch graphical user interface, according to an embodiment.

FIG. 9 illustrates a Freestyle Pitch graphical user interface according to an embodiment.

FIG. 10 illustrates a Scripted Pitch graphical user interface, according to an embodiment.

FIG. 11 illustrates an Explore graphical user interface, according to an embodiment.

FIG. 12 illustrates an Explore Scroll graphical user interface, according to an embodiment.

FIG. 13 illustrates a Pitch Battle graphical user interface, according to an embodiment.

FIG. 14 illustrates a Search Full Screen graphical user interface, according to an embodiment.

FIG. 15 illustrates a Search Full Screen graphical user interface, according to an embodiment.

FIG. 16 illustrates a Notification graphical user interface, according to an embodiment.

FIG. 17 illustrates a block chart of a method employing the sales training and recruitment utility with an autodialer.

### DETAILED DESCRIPTION

A sales training and recruitment utility with an autodialer as disclosed herein will become better understood through a review of the following detailed description in conjunction with the figures. The detailed description and figures provide merely examples of the various embodiments of a sales training and recruitment utility with an autodialer. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

The present invention can be provided on a computer readable non-transitory storage medium as non-transitory data storage. A computer readable non-transitory storage medium as non-transitory data storage includes any data stored on any suitable media in a non-fleeting manner. Such data storage includes any suitable computer readable non-transitory storage medium, including, but not limited to hard drives, non-volatile RAM, SSD devices, CDs, DVDs, etc. The present invention can include a non-transitory computer readable medium including a computer program, that when executed on a computer processor, can causes the computer processor to execute the sales training utility.

Conventional sales training platforms, software, and/or manuals can include systems and methods for instructing current or potential sale personnel. The existing systems are often structured around the product or service to be sold. The systems are not tailored or structured towards the sales personnel specifically and are not designed to improve or highlight individual aspects of the sales personnel's approach towards the consumer. Further, the systems are not conjured to allow recruiters to rate, analyze and choose specific sales personnel for specific projects and/or campaigns.

The existing conventional systems do not provide systems or methods that allow utilities (or software applications) to provide specific training exercises and practice routines for sales personnel that employ machine learning and/or artificial intelligent (AI) to assist with the training program. Further, existing systems do not provide interactive crowd sourcing assistance to rate and critique the sales personnel.

Further, the available sales training systems do not employ autodialers with or without artificial intelligence systems to provide added functionality to the training systems.

Further, the available sales training systems do not provide a recruitment method for potential employers to review, test and potentially hire sale personnel for marketing campaigns.

Implementation of a sales training and recruitment utility with an autodialer according to the present invention may address some or all of the problems described above. A sales training and recruitment utility with an autodialer can be configured to allow a potential sale personnel to access the utility and create a user profile on a biographical (BIO) graphical user interface. The sales training and recruitment utility with an autodialer can be configured to allow the sales personnel to update the BIO graphical user interface based on list of categories or the BIO graphical user interface can elicit information based on a narrative that changes based on the sales personnel's input. Questions, narratives, and/or categories can be varied in view of the inputs from the sale personnel and/or the marketing position that needs to be filled.

The sales training and recruitment utility with an autodialer can solve problems related to a specific sales personnel's sales techniques and/or it can be configured to give more general feedback based on expertise level or industry category. These can include tonality, cadence, word choice, timing, attitude, competency, facial features, or other criteria. Additionally, the sales training and recruitment utility with an autodialer can provide access to potential sale personnel by employers seeking to recruit and hire.

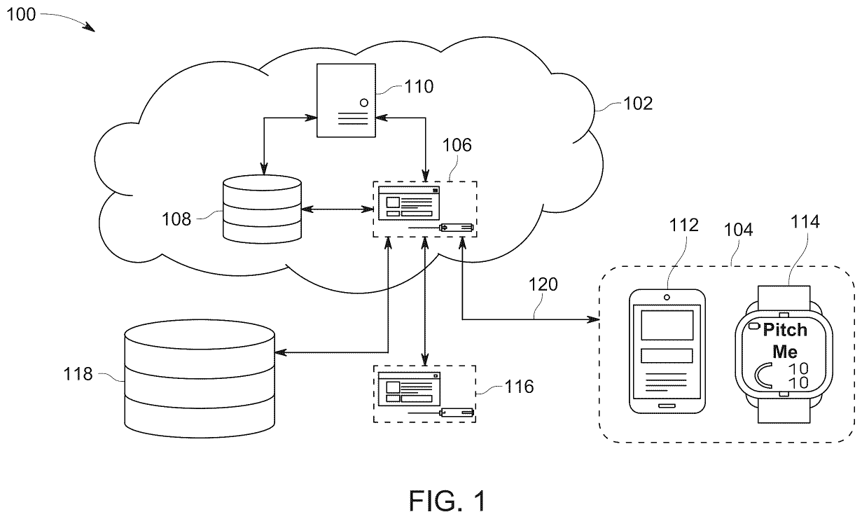

FIG. 1 illustrates a sales training and recruitment utility with an autodialer 100, according to an embodiment. The sales training and recruitment utility with an autodialer with an autodialer 100 includes internal and external data resources to provide sales training exercises, store biographical information and provide access to recruiters. The sales training and recruitment utility with an autodialer 100 may result in reduced memory allocation at client devices and may conserve memory resources for application servers.

The sales training and recruitment utility with an autodialer 100 may include a cloud-based data management system 102 and a user device 104 (the user device 104 can be operated by the sale personnel, a recruiter, or a sales training and recruitment utility with an autodialer manager). The cloud-based data management system 102 may include an application server 106, a database 108, and a data server 110. The user device 104 may include one or more devices associated with sale personnel profiles of the sales training and recruitment utility with an autodialer 100, such as a smartphone 112 and/or a smart watch 114. The sales training and recruitment utility with an autodialer 100 may include external resources such as an external application server 116 and/or an external database 118. The various elements of the sales training and recruitment utility with an autodialer 100 may communicate via various communication links 120. An external resource may generally be considered a data resource owned and/or operated by an entity other than an entity that utilizes the cloud-based data management system 102 and/or the user device 104.

The sales training and recruitment utility with an autodialer 100 may be web-based. The user device 104 may access the cloud-based data management system 102 via an online portal set up and/or managed by the application server 106. The sales training and recruitment utility with an autodialer 100 may be implemented using a public internet. The sales training and recruitment utility with an autodialer 100 may be implemented using a private intranet. Elements of the sales training and recruitment utility with an autodialer 100, such as the database 108 and/or the data server 110, may be physically housed at a location remote from an entity that owns and/or operates the sales training and recruitment utility with an autodialer 100. For example, various elements of the sales training and recruitment utility with an autodialer 100 may be physically housed at a public service provider such as a web services provider. Elements of the sales training and recruitment utility with an autodialer 100 may be physically housed at a private location, such as at a location occupied by the entity that owns and/or operates the sales training and recruitment utility with an autodialer 100.

The communication links 120 may be direct or indirect. A direct link may include a link between two devices where information is communicated from one device to the other without passing through an intermediary. For example, the direct link may include a Bluetooth™ connection, a Wifi Direct™ connection, a Zigbee® connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 120, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long-term evolution (LTE) standard, and so forth. “Indirect,” when used regarding the communication links 120, may refer to any of the aforementioned indirect communication links.

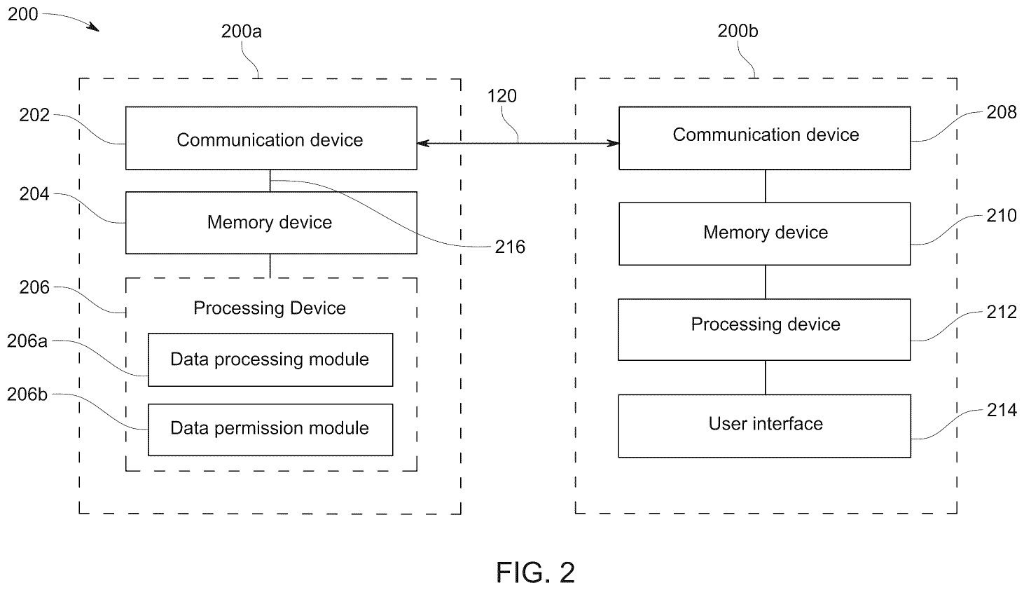

FIG. 2 illustrates a device schematic 200 for various devices used in the sales training and recruitment utility with an autodialer 100, according to an embodiment. A server device 200a may moderate data communicated to a client device 200b based on data permissions to minimize memory resource allocation at the client device 200b.

The server device 200a may include a communication device 202, a memory device 204, and a processing device 206. The processing device 206 may include a data processing module 206a and a data permissions module 206b, where module refers to specific programming that governs how data is handled by the processing device 206. The client device 200b may include a communication device 208, a memory device 210, a processing device 212, and a user interface 214. Various hardware elements within the server device 200a and/or the client device 200b may be interconnected via a system bus 216. The system bus 216 may be and/or include a control bus, a data bus, and address bus, and so forth. The communication device 202 of the server device 200a may communicate with the communication device 208 of the client device 200b.

The data processing module 206a may handle inputs from the client device 200b. The data processing module 206a may cause data to be written and stored in the memory device 204 based on the inputs from the client device 200b. The data processing module 206a may retrieve data stored in the memory device 204 and output the data to the client device 200b via the communication device 202. The data permissions module 206b may determine, based on permissions data stored in the memory device, what data to output to the client device 200b and what format to output the data in (e.g., as a static variable, as a dynamic variable, and so forth). For example, a variable that is disabled for a particular user profile may be output as static. When the variable is enabled for the particular user profile, the variable may be output as dynamic.

The server device 200a may be representative of the cloud-based data management system 102. The server device 200a may be representative of the application server 106. The server device 200a may be representative of the data server 110. The server device 200a may be representative of the external application server 116. The memory device 204 may be representative of the database 108 and the processing device 206 may be representative of the data server 110. The memory device 204 may be representative of the external database 118 and the processing device 206 may be representative of the external application server 116. For example, the database 108 and/or the external database 118 may be implemented as a block of memory in the memory device 204. The memory device 204 may further store instructions that, when executed by the processing device 206, perform various functions with the data stored in the database 108 and/or the external database 118.

Similarly, the client device 200b may be representative of the user device 104. The client device 200b may be representative of the smartphone 112. The client device 200b may be representative of the smart watch 114. The memory device 210 may store application instructions that, when executed by the processing device 212, cause the client device 200b to perform various functions associated with the instructions, such as retrieving data, processing data, receiving input, processing input, transmitting data, and so forth.

As stated above, the server device 200a and the client device 200b may be representative of various devices of the sales training and recruitment utility with an autodialer 100. Elements of the sales training and recruitment utility with an autodialer 100 may include data storage and/or processing capabilities. Such capabilities may be rendered by various electronics for processing and/or storing electronic signals. One or more of the devices in the sales training and recruitment utility with an autodialer 100 may include a processing device. For example, the cloud-based data management system 102, the user device 104, the smartphone 112, the smart watch 114, the external application server 116, and/or the external database 118 may include a processing device. One or more of the devices in the sales training and recruitment utility with an autodialer 100 may include a memory device. For example, the cloud-based data management system 102, the user device 104, the smartphone 112, the smart watch 114, the external application server 116, and/or the external database 118 may include the memory device.

The processing device may have volatile and/or persistent memory. The memory device may have volatile and/or persistent memory. The processing device may have volatile memory and the memory device may have persistent memory. Memory in the processing device may be allocated dynamically according to variables, variable states, static objects, and permissions associated with objects and variables in the sales training and recruitment utility with an autodialer 100. Such memory allocation may be based on instructions stored in the memory device. Memory resources at a specific device may be conserved relative to other systems that do not associate variables and other objects with permission data for the specific device.

The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device.

The devices in the sales training and recruitment utility with an autodialer 100 may include data communication capabilities. Such capabilities may be rendered by various electronics for transmitting and/or receiving electronic and/or electromagnetic signals. One or more of the devices in the sales training and recruitment utility with an autodialer 100 may include a communication device, e.g., the communication device 202 and/or the communication device 208. For example, the cloud-based data management system 102, the user device 104, the smartphone 112, the smart watch 114, the application server 116, and/or the external database 118 may include a communication device.

The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™ programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

Various of the elements in the sales training and recruitment utility with an autodialer 100 may be referred to as a “server. ” Such elements may include a server device. The server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data. ” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

Various devices in the sales training and recruitment utility with an autodialer 100, including the server device 200a and/or the client device 200b, may include a user interface for outputting information in a format perceptible by a user and receiving input from the user, e.g., the user interface 214. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various methods are described below. The methods may be implemented by the sales training and recruitment utility with an autodialer 100 and/or various elements of the sales training and recruitment utility with an autodialer described above. For example, inputs indicated as being received in a method may be input at the client device 200b and/or received at the server device 200a. Determinations made in the methods may be outputs generated by the processing device 206 based on inputs stored in the memory device 204. Correlations performed in the methods may be executed by the correlation module. Inference outputs may be generated by the inference module. Key data and/or actionable data may be stored in the knowledge database 204b. Correlations between key data and actionable data may be stored in the knowledge database 204b. Outputs generated in the methods may be output to the output database 204c and/or the client device 200b. In general, data described in the methods may be stored and/or processed by various elements of the sales training and recruitment utility with an autodialer 100.

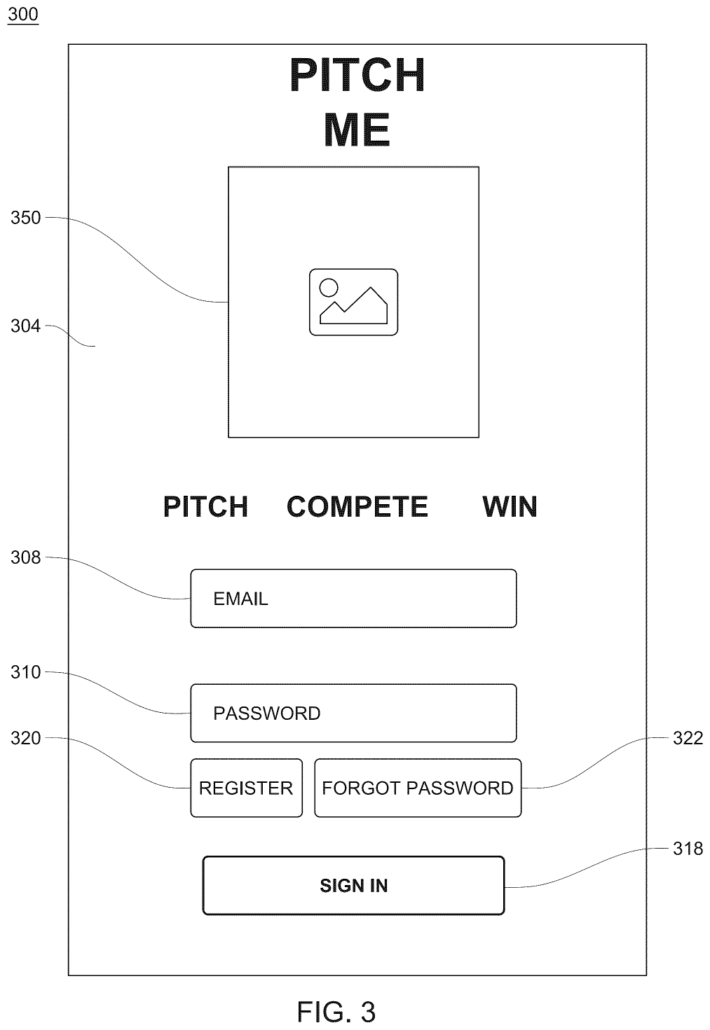

FIG. 3 illustrates a home graphical user interface 300 (home GUI 300) of an application for accessing the sales training and recruitment utility with an autodialer on a client device 200b, according to an embodiment. The application can be mobile, web-based, or run on any suitable computing device, such as client device 200b. The home graphical user interface 300 may be displayed on the client device 200b and enables access to the sales training and recruitment utility with an autodialer 300.

The first graphical user interface 300 (or home GUI 300) can enable a user to quickly enter the sales training and recruitment utility with an autodialer using log-in information. The first graphical user interface 300 may include a graphical organizer container 304 and one or more graphical data containers. The one or more graphical data containers may be nested in the graphical organizer container 304. A graphical organizer container 304 can have graphical user interface elements including an email text box 308, and a password textbox 310 and a sign in button 318. Alternatively, the user can log-in via another social media system, such as Facebook, Link-In, Google, or other available secure systems. The Home GUI 300 can further include a register button 320 and a forgot password button 322, these buttons will take the user to a GUI that will allow the user to create an account and/or recover their password via email, text, or other source. The Home GUI 300 can contains images 350, such as thumbnails that represent the utility 100.

The sign in button 318 will execute the sign-in information entered in the textboxes 306, 310 and provide access to the sales training and recruitment utility with an autodialer 100. Initially, a user will access the BIO graphical user interface 400 to create a user profile.

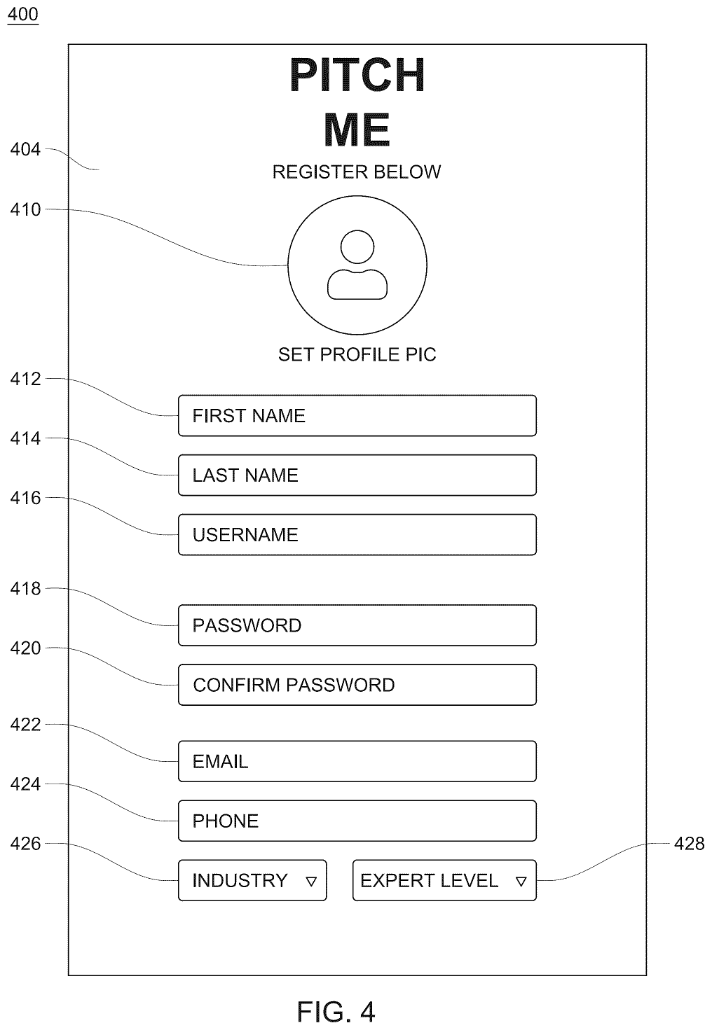

FIG. 4 illustrates a BIO graphical user interface 400, according to an embodiment. The BIO GUI 400 includes a graphical organizer container 404 that can includes a profile picture button 410 that can be populated with an avatar, an image, a photo of the user, icons, logos, or other identifying symbols or images. The user can click on the profile picture button 410, upload a photo, image or avatar, and the image will appear where the profile picture button 410 is located. The graphical organizer container 404 can further contain text boxes 412, 414, for entering personal information about the user, such as first and last name. A username text box 416 will allow the user to create an individual user name. Additionally text boxes for creating an account are located on the BIO GUI 400, which allow the user to enter a new password via a password text box 418 and confirm password text box 420. Additional text boxes can include information including, but not limited to, email address text box 422, phone number text box 424, as well as other text boxes for other personal information.

Drop down boxes can be included on the BIO GUI 400 that include an industry drop down box 426, and an expert level drop down box 428. The industry drop down box 426 can have selections including, but not limited to automotive, telecom, medical, insurance, music, homeware, appliances, electronics, apparel, sports equipment, movies, entertainment, solar, real estate, automotive, software, merchant services, insurance, telecom, marketing, professional services, home improvement, and other industries. The expert level drop down box 428 can include selections including, but not limited to, novice, intermediate, expert, as well as gradations between these levels. The graphical organizer container 405 can further contain an execute button or submit button that uploads the personal information into a database.

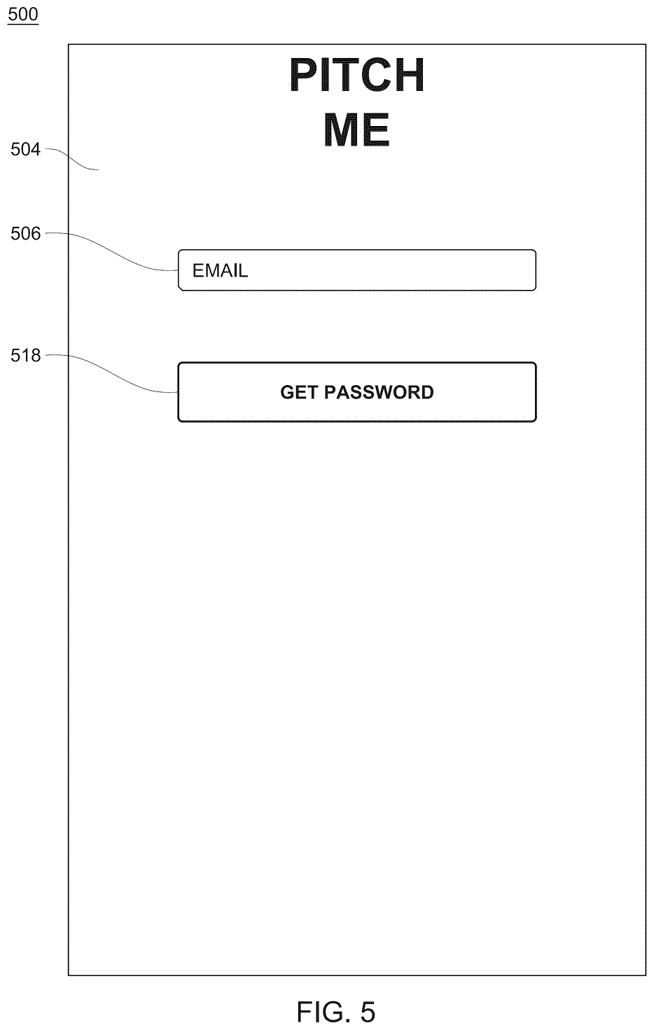

FIG. 5 illustrates a Retrieve Password graphical user interface 500, according to an embodiment. The Retrieve Password GUI 500 can includes a graphical organizer container 504 that can include an email text box 506 for entering the user's email address. The graphical organizer container 505 can further include a get password button 518 that will send password retrieval information (stored in a database) to the user's email address to enable the user to log-in to the utility 100. The get password (or execute) button 518 will send the user back to the Home GUI 300. Additionally, after pressing the get password button 518 a message will appear that informs the user a link has been sent to their email address on file to recover/change the password.

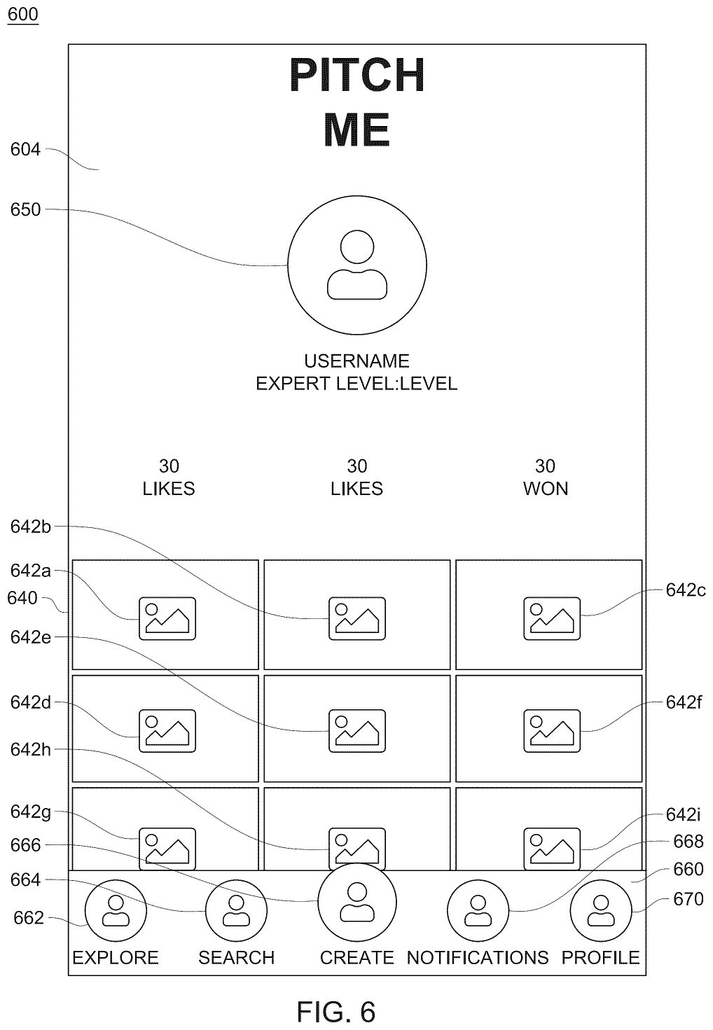

FIG. 6 illustrates a Profile graphical user interface 600, according to an embodiment. The Profile GUI 600 can include a graphical organizer container 604 that can include a profile picture 650 below which can be located the user's username and additional biographical information in text form. Additional text that can be located below the profile picture that can include the number of pitches that the user has created, the number of other users the user is following, the number of followers that have followed the user, the number of likes the user has received, the number of pitch battles won, and an artificial intelligence (AI) score for the user. Additional information specific to the user can be listed below the profile picture. The number of pitches, followers and following can be updated in real time.

The Profile GUI 600 can include a second graphical organizer container 640 that can include thumbnail images of pitches 642a, 642b, 642c, 642d, 642e, 642f, 642g, 642h, 642i created by the user or saved by the user and created by other users. Each of the pitch thumbnails 642a-i can be linked to a different pitch video. Pressing on a pitch thumbnail 642a-i can send the user to a Profile Full Screen GUI 700.

FIG. 6 further illustrates a third graphical organizer container 660 that can include buttons for other features in the sales training and recruitment utility with an autodialer 100 (or sales pitch utility 100 or utility 100). The third graphical organizer container 660 can include buttons for explore 662, search 664, create 666, notifications 668, and profile 670 that can provide access to various features of the sales training and recruitment utility with an autodialer 100.

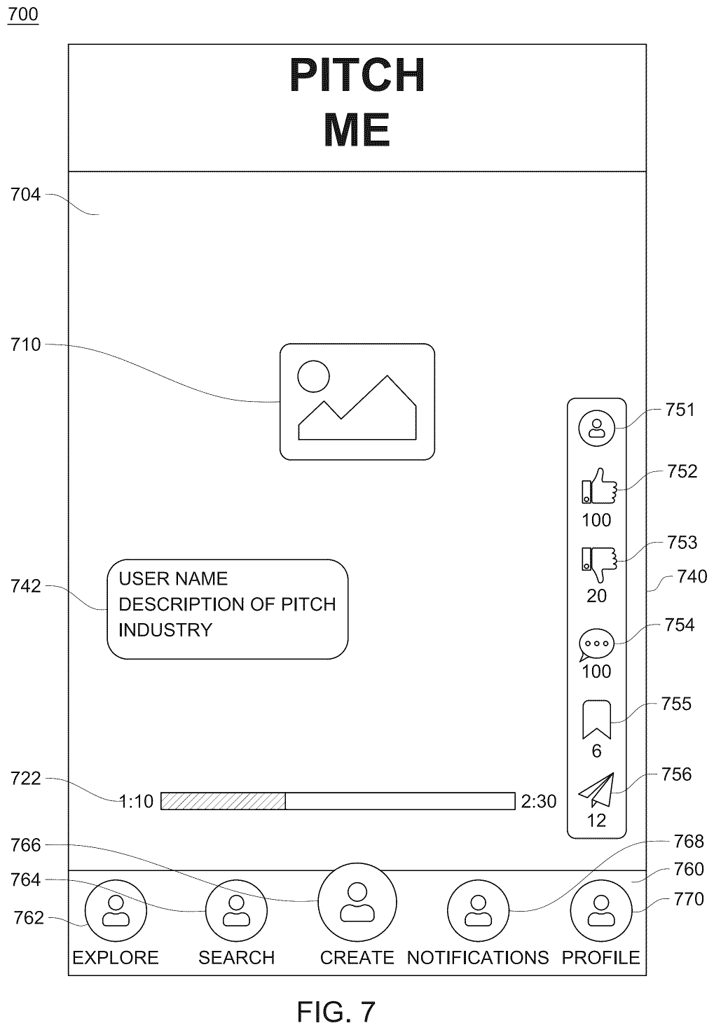

FIG. 7 illustrates a Profile Full Screen graphical user interface 700, according to an embodiment. Profile Full Screen GUI 700 can include a first graphical organizer container 704 that can display a pitch video 710 previously created by the user. Superimposed on the pitch video 710 can be a third graphical container 740 that can include icons that provide information about the pitch video 710. The icons can include a profile picture icon 751, an upvote icon 752, a down vote icon 753, a speech bubble icon 754, a bookmark icon 755, and a paper airplane icon 756. The profile picture icon 751 displays the profile picture of the user that created the pitch video. The upvote icon 752 and down vote icon 753 show the votes for or against the pitch video 710. The speech bubble icon 754 can display comments on the pitch video 750 by other users. The bookmark icon 755 can allow the user to favorite and save the pitch video 710, it can also allow a user to follow other users. The paper airplane icon 756 allows the user to share the pitch video 710 with other users via social media, text, email, or other methods. Additionally superimposed on the pitch video 710 can be media control features that can include pause, stop, rewind, play, fast forward, volume, and other features that allow the user to scroll thought the pitch video. Additionally, superimposed on the pitch video 710 can be an information bubble 742 that can provide an indication of the location of the creator of the pitch video, a description, category, expert level, total number of views of pitch video, as well as other information about the pitch video.

Artificial intelligence and/or machine learning can be employed to analyze the pitches recorded, saved, and posted in the sales pitch utility 100. Artificial intelligence and/or machine learning can be employed to provide rating, analysis, and/or critiques of user's pitches based on tonality, word choose, sentence structure, grooming, cadence, as well as other criteria. A score can be created and applied for individual categories of the sales pitch, or an aggregate score can be provided employing the above techniques. The ratification intelligence and/or machine learning can analyze the audio and the video using facial recognition technology, speech recognition technology, and other systems/technologies. The AI can be able to formulate objections, comments, rebuttals, scripts, and other analysis. Facial recognition can track eye contact of salespersons, customers, pitch battlers, and debaters. These same techniques can be employed in the Pitch Battles, Feed Page, Saved Pitches, Debates, and anywhere of use in the sales pitch utility 100.

FIG. 7 further illustrates a third graphical organizer container 760 that can include buttons for other features in the sales training and recruitment utility with an autodialer 100. The third graphical organizer container 760 can include buttons for explore 762, search 764, create 766, notifications 768, and profile 770 that provide access to various features of the sales training and recruitment utility with an autodialer 100.

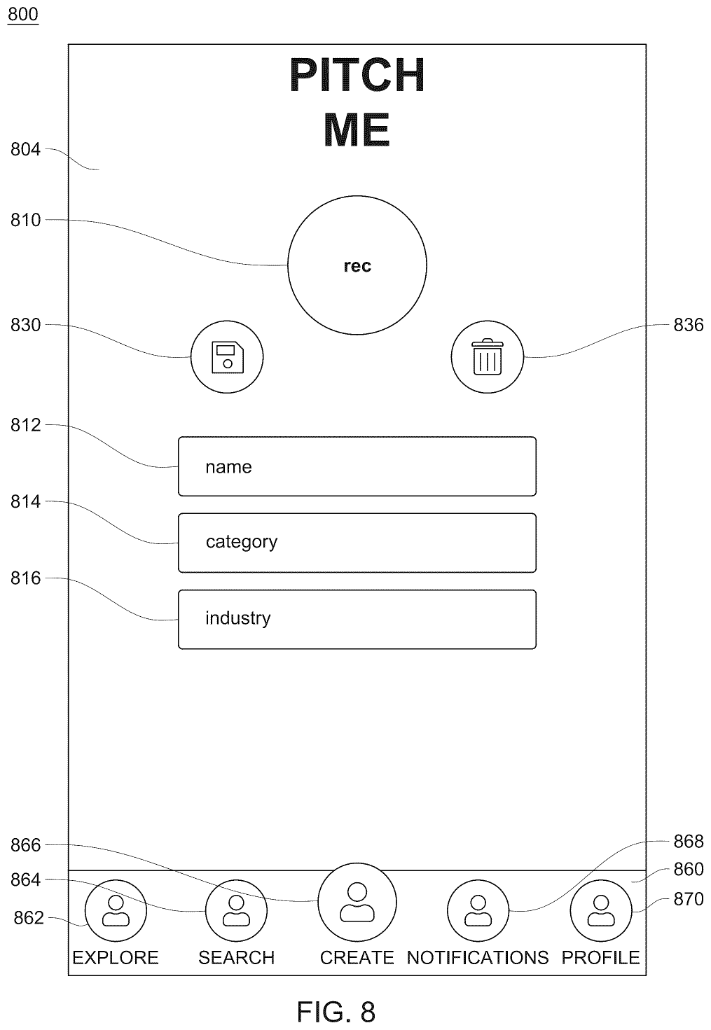

FIG. 8 illustrates a Record Pitch graphical user interface 800, according to an embodiment. The Record Pitch GUI 800 can be configured to allow the user to upload a video of a sales pitch to the sales training and recruitment utility with an autodialer 100. The Record Pitch GUI 800 can be configured to access the microphone and video camera of the user device and record audio and visual data provided by the user. The first graphical container 804 can further include a save button 830 and a delete button 836.

The Record Pitch GUI 800 can include a first graphical organizer container 804 that includes a record button 810. Pressing the record button 810 can allow the utility 100 to access the video camera and microphone of the user device and begin recoding a pitch from the user. The graphical organizer container 804 can further include a name text box 812, a category text box 814, and an industry text box 816. The name text box 812 allows the user to name the pitch video to be recorded. The category text box 814 allows the user to choose a category that the pitch video will be included in (such as scripted, freestyle or battle). The industry text box 816 can allow the user to choose or write an industry in which the pitch video will be included, such as the industries described above. The industry options can include, automotive, telecom, medical, insurance, music, homeware, appliances, electronics, apparel, sports equipment, movies, entertainment, solar, real estate, automotive, software, merchant services, insurance, telecom, marketing, professional services, home improvement, as well as other categories that will be evident to persons skilled in the art of sales pitches.

FIG. 8 further illustrates a second graphical organizer container 860 that can include buttons for other features in the sales training and recruitment utility with an autodialer 100. The second graphical organizer container 860 can include buttons for explore 862, search 864, create 866, notifications 868, and profile 870 that provide access to various features of the sales training and recruitment utility with an autodialer 100.

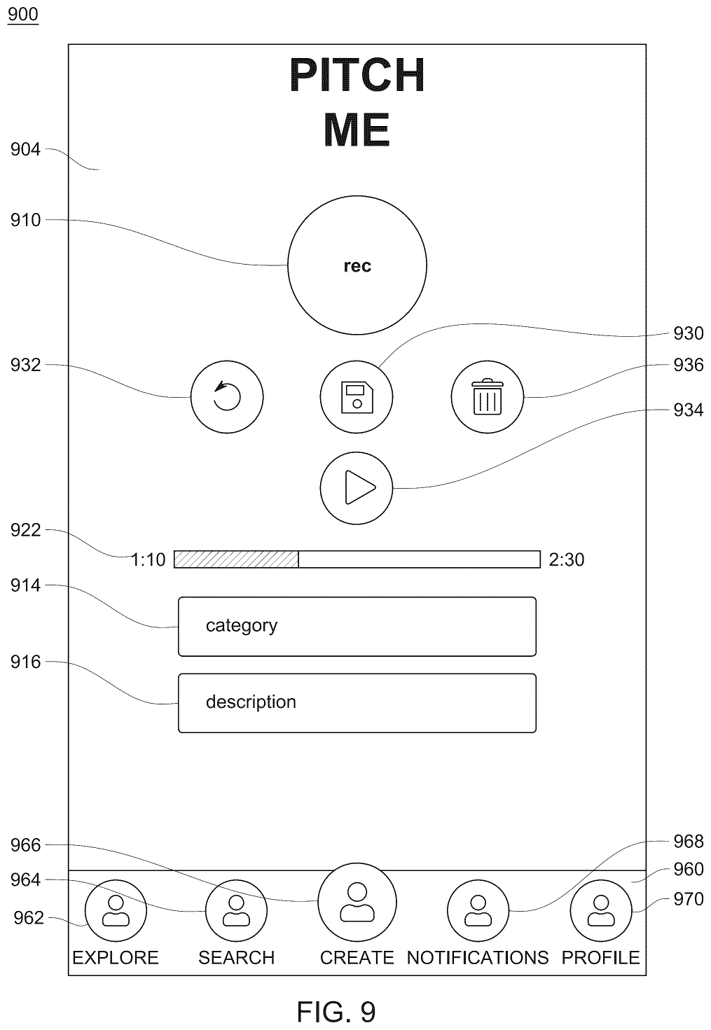

FIG. 9 illustrates a Freestyle Pitch GUI 900, according to an embodiment. The Freestyle Pitch GUI 900 includes a first graphical organizer container 904 that can include a record button 910 that allows the user to record pitches as previously described. The first graphical organizer container 904 can further include a categories text box 914, and a description text box 916 to allow the user to identify the pitch video based on a user created description and/or a category. Categories can include, but are not limited to automotive, telecom, medical, insurance, music, homeware, appliances, electronics, apparel, sports equipment, movies, entertainment, and as described above.

The first graphical organizer container 904 can further include a save button 930, a delete button 936, and a redo button 932 that can allow the user to save and upload the pitch video, delete the pitch video, or redo the filming of the pitch video. The first graphical organizer container 904 can further include a play button 934 that allows the user to play the pitch video after it has been recorded.

The first graphical organizer container 904 can further include progress bar 922 that shows the length of the video and audio being recorded and can operate as a slider for replay.

FIG. 9 further illustrates a third graphical organizer container 960 that can include buttons for other features in the sales training and recruitment utility with an autodialer 100. The third graphical organizer container 960 can include buttons for explore 962, search 964, create 966, notifications 968, and profile 970 that provide access to various features of the sales training and recruitment utility with an autodialer 100.

After the user has completed a freestyle pitch using the Freestyle Pitch GUI 900 an artificial intelligence created message can appear on the Freestyle Pitch GUI 900 providing insight to the user on the video pitch. The insights and advice can include critiques and advice on how the pitch was conducted, including tonality, cadence, word selection, facial expressions, pausing and pacing, role-playing, objection handling practice, persuasive language, cultural sensitivity, as well as other criteria.

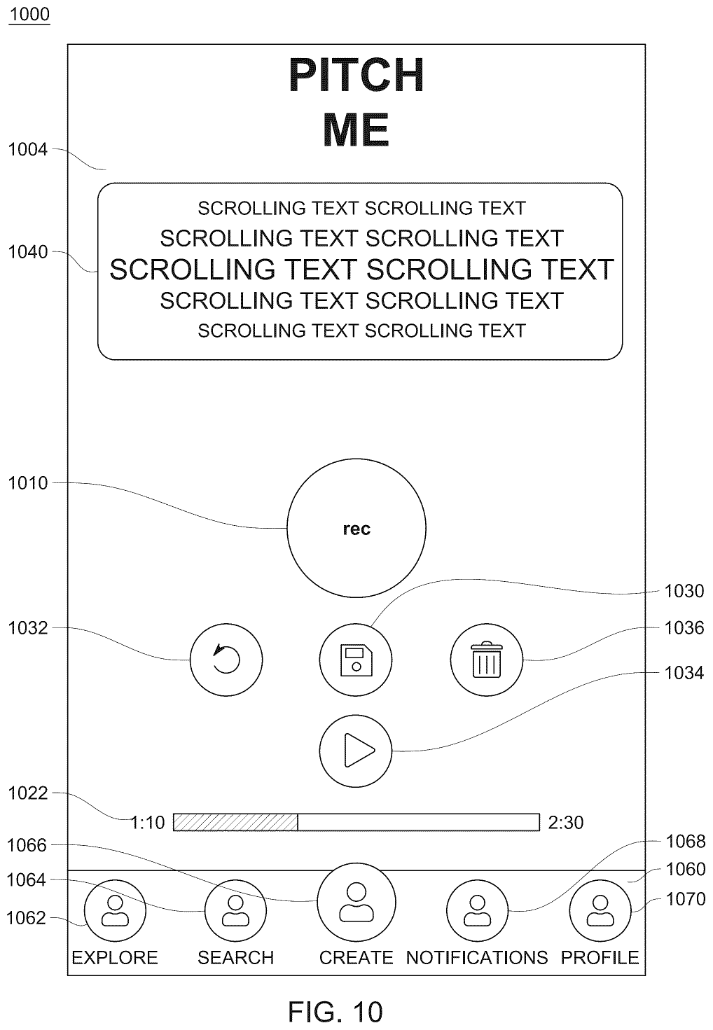

FIG. 10 illustrates a Scripted Pitch GUI 1000, according to an embodiment. The Scripted Pitch GUI 1000 can allow the user to create a pitch video based on a pre-written script provided from a database. The pre-written script can be varied in view of the category and expert level chosen by the user. The Scripted Pitch GUI 1000 can include a first graphical organizer container 1004 that can include a record button 1010 that allows the user to record pitches as previously described. The first graphical organizer container 1004 can further include a save button 1030, a delete button 1036, and a redo button 1032 that allow the user to save and upload the pitch video, delete the pitch video, or redo the filming of the pitch video. A video of the user can be captured and displayed below the teleprompter style word scroll while the pitch is being recorded. The first graphical organizer container 1004 can further include a play button 1034 that allows the user to play the pitch video after it has been recorded. The first graphical organizer container 1004 can further include progress bar 1022 that allow the user to scroll thought the pitch video after recording.

Further, the first graphical organizer container 1004 can further include a script text box 1040 that provides a previously prepared script to scroll at the appropriate speed for the user to read while recording the pitch video. The previously prepared script can be created by the utility developers, prior users, or artificial intelligence. The scripts are tailored towards certain categories, expert levels, length of pitches, as well as other criteria that can be chosen by the user.

FIG. 10 further illustrates a second graphical organizer container 1060 that can include buttons for other features in the sales training and recruitment utility with an autodialer 100. The second graphical organizer container 1060 can include buttons for explore 1062, search 1064, create 1066, notifications 1068, and profile 1070 that provide access to various features of the sales training and recruitment utility with an autodialer 100.

After the user has completed a pitch using the Scripted Pitch GUI 1000 an artificial intelligence created message can appear on the Scripted Pitch GUI 1000 providing insight to the user on the video pitch. The insights and advice can include critiques and advice on how the pitch was conducted, including tonality, cadence, word selection, facial expressions, immediate adjustments, interactive simulations, behavioral cues, empathy training, mood matching, sentiment analysis, predictive feedback, post-pitch analytics, personalized training modules, feedback loop integration, ai-assisted peer review, team training coordination, as well as other criteria.

Further, after the user has chosen to save the pitch video, either in the Scripted Pitch GUI 1000 or the Freestyle Pitch GUI 900, a save pitch text box can appear allowing the user to provide a file name for the newly recorded pitch video.

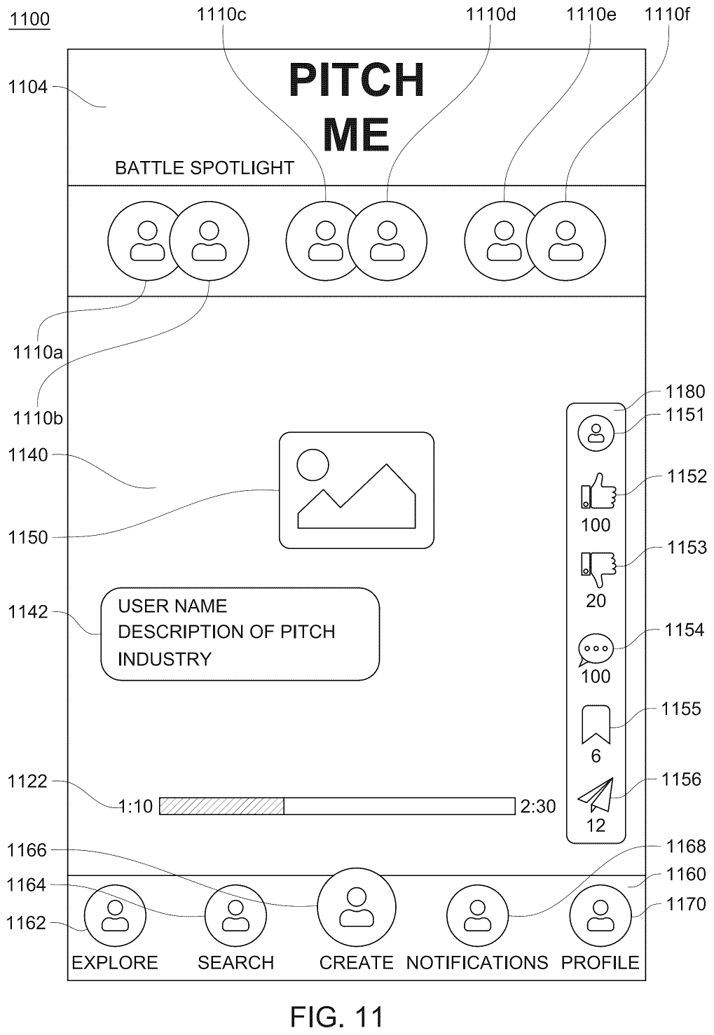

FIG. 11 illustrates an Explore GUI 1100, according to an embodiment. The Explore GUI 1100 allows the user to monitor pitch battles that are happening in real time and to view pitch battles that have ended. The Explore GUI 1110 includes a first graphical organizer container 1104 that can include profile pictures 1110a, 1110b, 1110c, 1110d of users engaged in pitch battles. Clicking on the profile pictures will bring the user to the pitch battles on a separate GUI.

FIG. 11 further includes a second graphical organizer container 1140 that displays pitch videos 1150 from other users. Progress bar 1122 operates similar to prior progress bars for video replay described above. Similar to the Profile Full Screen GUI 700, the Explore GUI 1100 can include pitch videos 1150, but the pitch videos can be from other users. Superimposed on the pitch video 1150 can be a third graphical container 1180 that can include icons that provide information about the pitch video 1150. The icons can include a profile picture icon 1151, an upvote icon 1152, a down vote icon 1153, a speech bubble icon 1154, a bookmark icon 1155, and a paper airplane icon 1156. The profile picture icon 1151 displays the profile picture of the user that created the pitch video. The upvote icon 1152 and down vote icon 1153 allow the user to vote for or against the pitch video 1150. The speech bubble icon 1154 will display comments on the pitch video 1150 by other users. The bookmark icon 1155 allows the user to favorite and save the pitch video 1150. The paper airplane icon 1156 allows the user to share the pitch video 1150 with other users via social media, text, email or other methods. Below each of the above-described icons can be a number that indicates the number of up votes, down votes, comments, bookmarks, and shares (these features can be employed in all similar GUI's). Additionally superimposed on the pitch video 1150 can be media control features that can include pause, stop, rewind, play, fast forward, volume, and other features that allow the user to scroll thought the pitch video. Additionally, superimposed on the pitch video 1150 can be an information bubble 1142 that can provide the location of the creator of the pitch video, a description, category, expert level, total number of views of pitch video, as well as other information about the pitch video.

FIG. 11 further illustrates a fourth graphical organizer container 1160 that can include buttons for other features in the sales training and recruitment utility with an autodialer 100. The fourth graphical organizer container 1160 can include buttons for explore 1162, search 1164, create 1166, notifications 1168, and profile 1170 that provide access to various features of the sales training and recruitment utility with an autodialer 100.

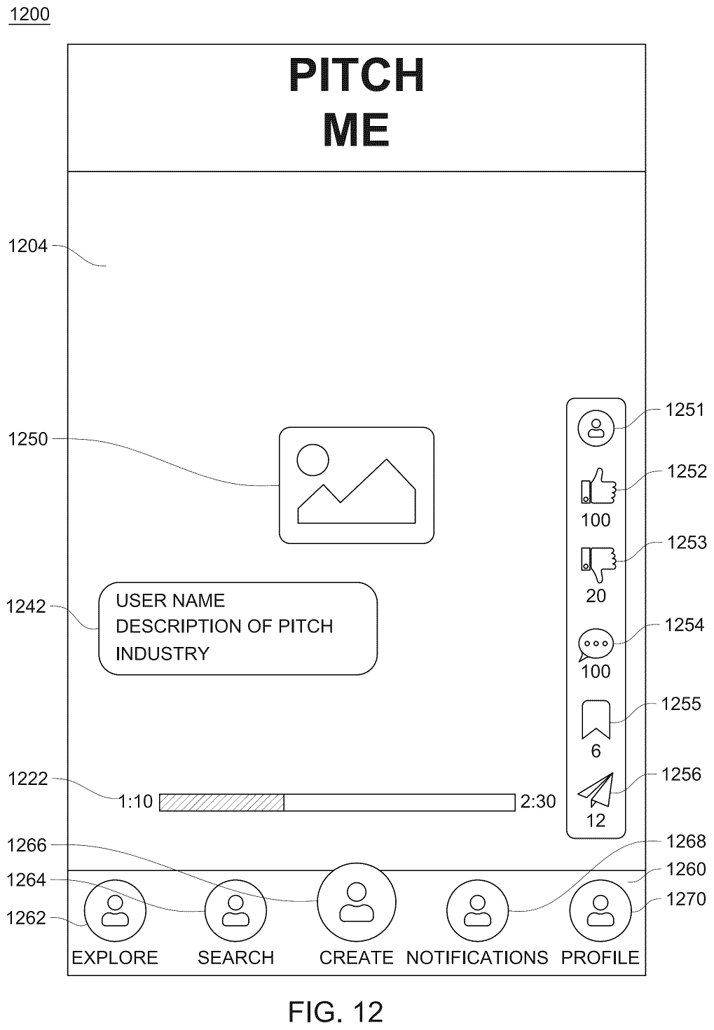

FIG. 12 illustrates an Explore Scroll GUI 1200, according to an embodiment. The Explore Scroll GUI 1200 includes a full-page display of the pitch videos by other users. When the user scrolls on the second graphical container 1140 from the Explore GUI 1100, the pitch battle graphical organizer container 1104 can disappear and the second graphical organizer container 1140 can fill the full screen, this will be referred to as the Explore Scroll GUI 1200. Similar to the features discussed in FIG. 11, the Explore Scroll GUI 1200 can include a graphical organizer container 1204 that can display pitch videos 1250 from other users. The first graphical organizer 1204 can further include a progress bar 1222.

The Explore Scroll Page GUI 1200 can include pitch videos 1250, but the pitch videos can be from other users. Superimposed on the pitch video 1250 can be a third graphical container 1280 that can include icons that provide information about the pitch video 1250. The icons can include a profile picture icon 1251, an upvote icon 1252, a down vote icon 1253, a speech bubble icon 1254, a bookmark icon 1255, and a paper airplane icon 1256. The profile picture icon 1251 displays the profile picture of the user that created the pitch video. The upvote icon 1252 and down vote icon 1253 allow the user to vote for or against the pitch video 1250. The speech bubble icon 1254 will display comments on the pitch video 1250 by other users. The bookmark icon 1255 allows the user to favorite and save the pitch video 1250. The paper airplane icon 1256 allows the user to share the pitch video 1250 with other users via social media, text, email or other methods. Additionally superimposed on the pitch video 1250 can be media control features that can include pause, stop, rewind, play, fast forward, volume, and other features that allow the user to scroll thought the pitch video. Additionally, superimposed on the pitch video 1250 can be an information bubble 1242 that can provide a location of the creator of the pitch video, a description, category, expert level, total number of views of pitch video, as well as other information about the pitch video.

FIG. 12 further illustrates a fourth graphical organizer container 1260 that can include buttons for other features in the sales training and recruitment utility with an autodialer 100. The fourth graphical organizer container 1260 can include buttons for explore 1262, search 1264, create 1266 notifications 1268, and profile 1270 that provide access to various features of the sales training and recruitment utility with an autodialer 100.

While the user is on the Explore GUI 1100 or the Explore Scroll GUI 1200 a pop-up message can appear that invites the user to a pitch battle. The pop-up message can include an indication of the other user inviting the user to the pitch battle (or a debate), the category, description and expert level of the pitch battle (or debate), and other relevant information on the pitch battle (or debate). If a user accepts a battle request (or debate request) but is currently battling (or debating), the request will be put in a queue until the user is free to battle (or debate). The queue can include between 2 and 20 users, between 3 and 10 user, and preferably 3 users. The pop-up message can include an accept button and a decline button that will allow the user to choose to engage in the pitch battle (or debate).

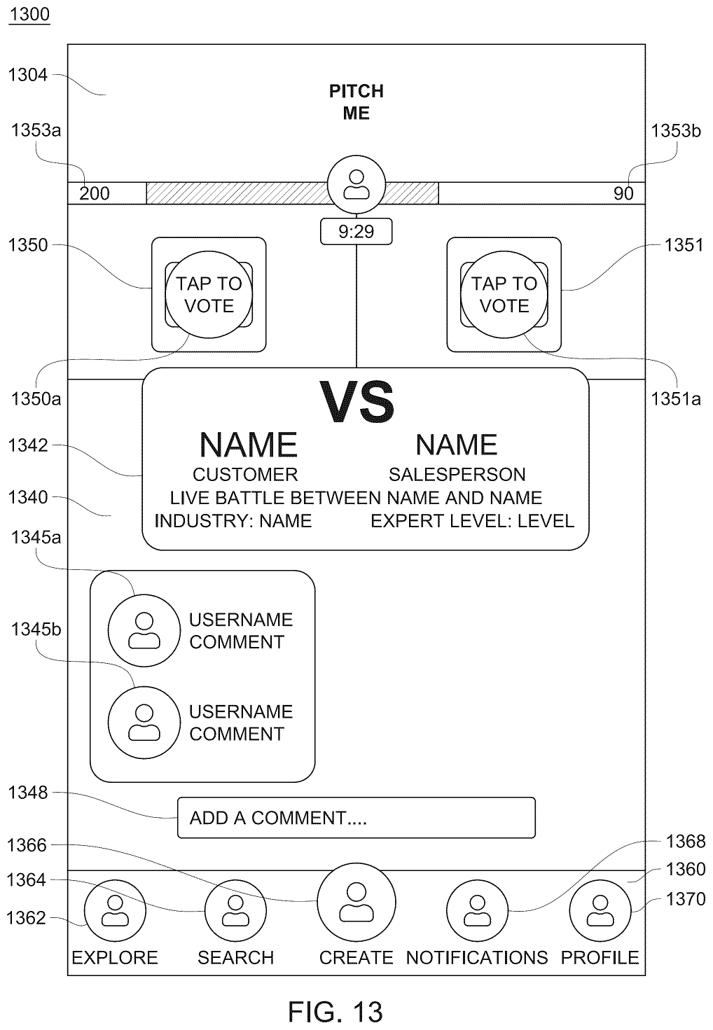

FIG. 13 illustrates the Pitch Battle GUI 1300, according to an embodiment. The Pitch Battle Page GUI can include a first graphical organizer container 1304 that can include sales pitch video 1350 and a customer video 1351 (or first debater 1350 and second debater 1351). The Pitch Battle GUI 1300 displays a live (or recorded) pitch battle in which one user acts as the sale personnel providing a sales pitch, and the second user acts as the customer receiving the sales pitch. The first graphical organizer container 1304 can further include an information bubble 1342 that can include profile pictures of the users engaged in the pitch battle, the position of each user (i.e. salesperson or customer); a description of the type of pitch, the category that the pitch takes place in (automotive, telecom, etc.), the class or expert level of the pitch such as novice, intermediate, expert, etc., and other possible descriptions. Embodiment can also include can a live video of battle of both participants. A debate GUI can operate in a similar fashion to the Pitch Battle GUI 1300 described above.

Superimposed on the sales pitch video 1350 can be a user icon 1350a of the user performing the sales pitch video, and superimposed on the customer video can be a user icon 1351a of the user performing the customer video 1351. The sale pitch video user icon 1350a and customer video user icon 1351a can also be voting buttons to choose which pitch the user decides is performing better.

In a second graphical organizer container 1340 user comments, as well as profile pictures of the users next to the comments can be displayed 1345a, b, c, etc. The comments can be uploaded and displayed in real time during the pitch battle. Further, users can cast votes for either the sales personnel or the customer that will appear in real time on the Pitch Battle GUI 1300 either in numerical fashion, or as a status bar 1353a, 1353b above the sales pitch video 1350 and a customer video 1351. Users can cast as many votes as they choose during the pitch battle or they can be limited to one vote per pitch battle, additional variations are possible. Votes can be cast by clicking a vote button (not shown) underneath the username of each contestant, or directly on the video of each contestant. User comments can be inputted in the user comment text box 1348. A debate GUI can operate in a similar fashion to the Pitch Battle GUI 1300 described above.

Pitch battles can be timed or untimed. If timed, they can be between five minutes and an hour in length. Other variations can include ten, fifteen, twenty, thirty, forty-five minutes or other variations. A preferred time limit will be ten minutes in length for the total pitch battle.

FIG. 13 further illustrates a fourth graphical organizer container 1360 that can include buttons for other features in the sales training and recruitment utility with an autodialer 100. The fourth graphical organizer container 1360 can include buttons for explore 1362, search 1364, create 1366, notifications 1368, and profile 1370 that provide access to various features of the sales training and recruitment utility with an autodialer 100.

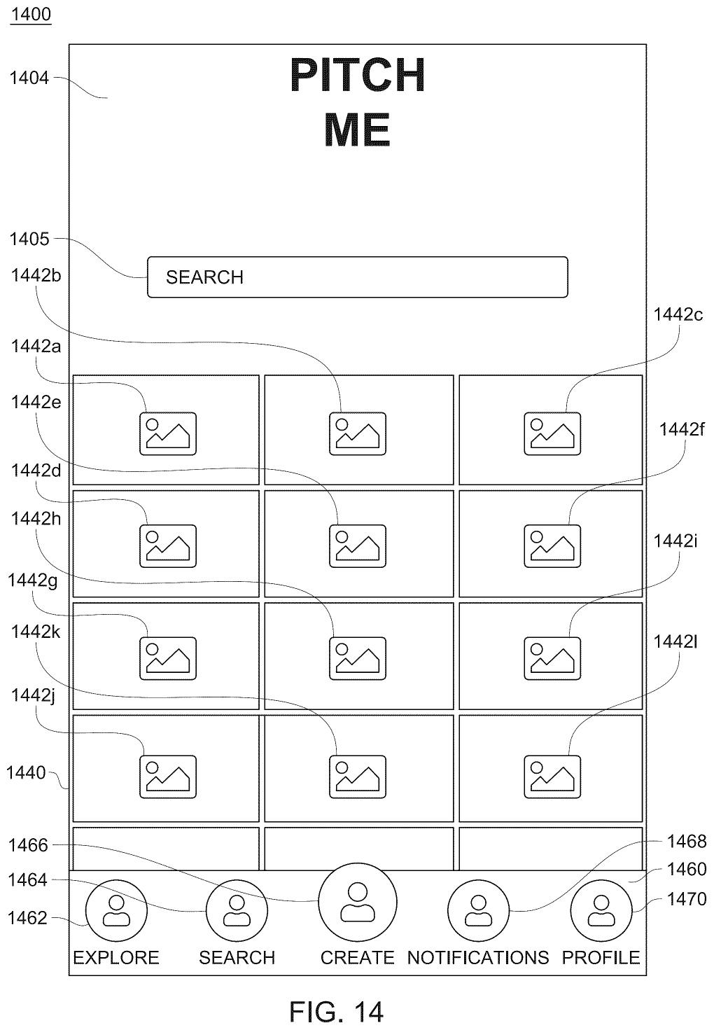

FIG. 14 illustrates a Search GUI 1400, according to an embodiment. The Search GUI 1400 can includes a graphical organizer container 1404 that can includes a search text box 1405 that will allow the user to input information, descriptions, user names, or other search criteria that can be used to search prior recorded pitch videos that have been bookmarked, saved by the user, stored in a database, or stored via another criteria. This GUI format can be used when the user pushes the search button, or a bookmark button.

The Search GUI 1400 can include a second graphical organizer container 1440 that can include thumbnail images of saved pitches 1442a, 1442b, 1442c, 1442d, 1442e, 1442f, 1442g, 1442h, 1442i saved by the user or saved as bookmarked videos from other users. Each of the saved pitch thumbnails 1442a-i can be linked to a different saved pitch video. Pressing on a pitch thumbnail 1442a-i can send the user to Search Full Screen GUI 1500.

FIG. 14 further illustrates a third graphical organizer container 1460 that can include buttons for other features in the sales training and recruitment utility with an autodialer 100. The third graphical organizer container 1460 can include buttons for explore 1462, search 1464, create 1466, notifications 1468, and profile 1470 that provide access to various features of the sales training and recruitment utility with an autodialer 100.

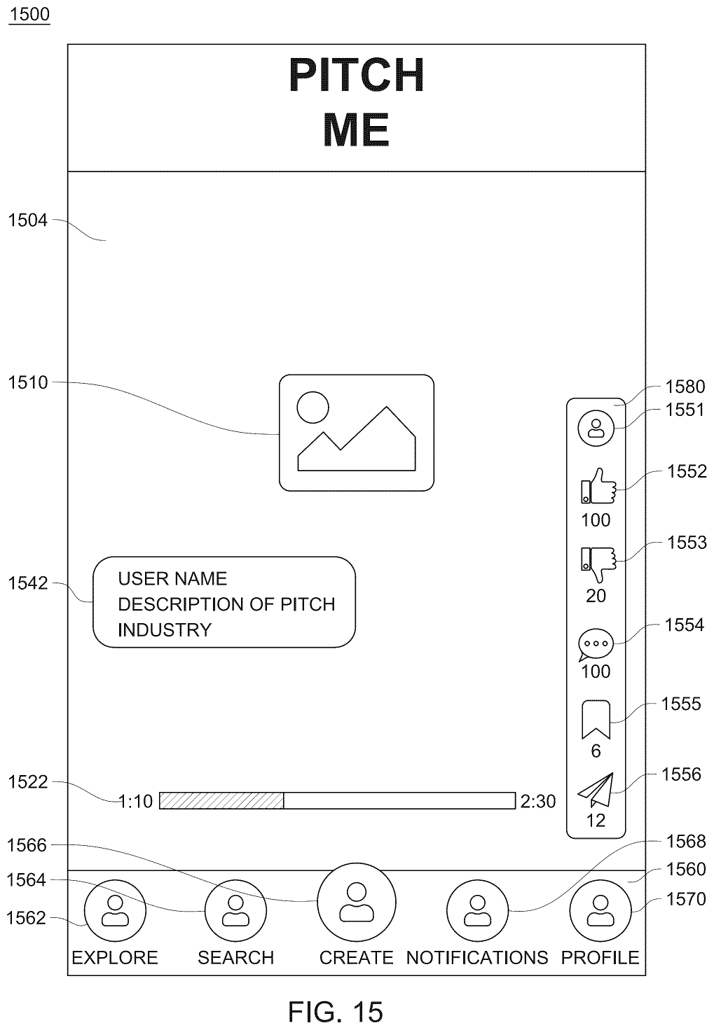

FIG. 15 illustrates a Search Full Screen GUI 1500, according to an embodiment. Search Full Screen GUI 1500 can include a first graphical organizer container 1504 that can display a saved pitch video 1510 previously created by the user or other users. FIG. 15 further includes a graphical organizer container 1504 that displays pitch videos 1510 from other users. Similar to the Profile Full Screen GUI 700, the Search Full Screen GUI can include pitch videos 1510, but the pitch videos can be from other users. Superimposed on the pitch video 1510 can be a second graphical container 1580 that can include icons that provide information about the pitch video 1510. The icons can include a profile picture icon 1551, an upvote icon 1552, a down vote icon 1553, a speech bubble icon 1554, a bookmark icon 1555, and a paper airplane icon 1556. The profile picture icon 1551 displays the profile picture of the user that created the pitch video. The upvote icon 1552 and down vote icon 1553 allow the user to vote for or against the pitch video 1550. The speech bubble icon 1554 will display comments on the pitch video 1510 by users. The bookmark icon 1555 allows the user to favorite and save the pitch video 1510. The paper airplane icon 1556 allows the user to share the pitch video 1510 with other users via social media, text, email or other methods. Additionally superimposed on the pitch video 1510 can be media control features that can include pause, stop, rewind, play, fast forward, volume, and other features that allow the user to scroll thought the pitch video. Additionally, superimposed on the pitch video 1510 can be an information bubble 1542 the provides the location of the creator of the pitch video, a description, category, expert level, total number of views of pitch video, as well as other information about the pitch video.

FIG. 15 further illustrates a third graphical organizer container 1560 that can include buttons for other features in the sales training and recruitment utility with an autodialer 100. The third graphical organizer container 1560 can include buttons for explore 1562, search 1564, create 1566, notifications 1568, and profile 1570 that provide access to various features of the sales training and recruitment utility with an autodialer 100.

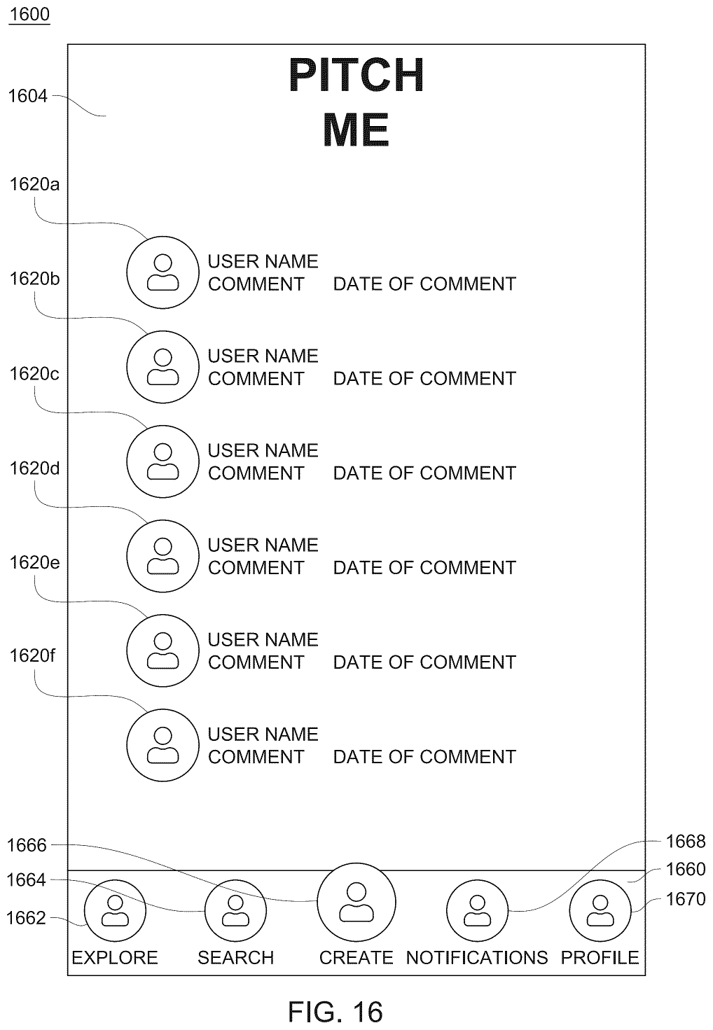

FIG. 16 illustrates a Notification GUI 1600 according to an embodiment. A Notification GUI 1600 can include a first graphical organizer container 1604 that includes comments from other users 1620a, b, c, d, e, f. FIG. 16 can further includes a graphical organizer container 1504 that displays pitch videos 1510 from other users.

FIG. 16 further illustrates a second graphical organizer container 1660 that can include buttons for other features in the sales training and recruitment utility with an autodialer 100. The second graphical organizer container 1660 can include buttons for explore 1662, search 1664, create 1666, notifications 1668, and profile 1670 that provide access to various features of the sales training and recruitment utility with an autodialer 100.

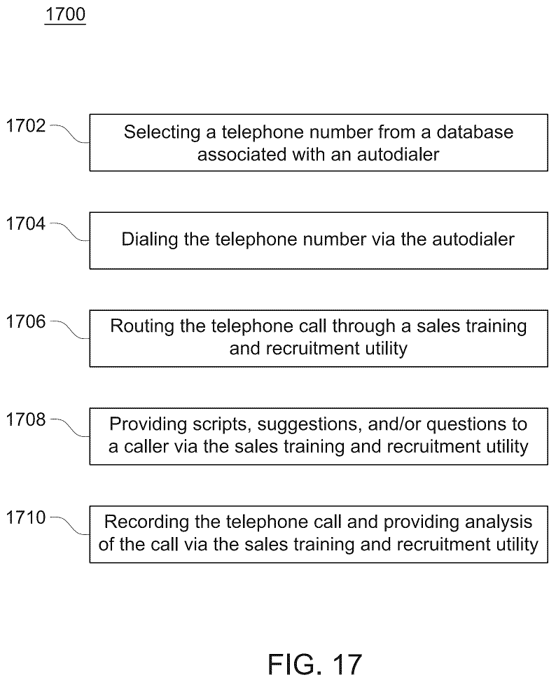

FIG. 17 illustrates a block chart of a method 1700 of using the sales training and recruitment utility with an autodialer 100. The method 1700 for using the sales training and recruitment utility with an autodialer 100 can include the steps of 1702 selecting a telephone number from a database associated with an autodialer. Step 1704 can include dialing the telephone number via the autodialer. Step 1706 can include routing the telephone call through a sales training and recruitment utility. Step 1708 can include providing scripts, suggestions, and/or questions to a caller via the sales training and recruitment utility. Step 1710 can include recording the telephone call and providing analysis of the call via the sales training and recruitment utility.

The autodialer for use with the sales training and recruitment utility of the present invention can include integrated artificial intelligence powered phone system with a predictive autodialer. The autodialer can provide a comprehensive phone system capable of receiving and making phone calls. The autodialer can integrate artificial intelligence driven capabilities, allowing the sales training and recruitment utility to include communication and training tools for businesses.

The autodialer can further include full phone system integration that allows inbound and outbound call handling. The autodialer can further include call routing, voicemail, IVR (interactive voice Response), and conferencing.

The autodialer can further provide artificial intelligence powered call monitoring and training. The autodialer in combination with the sales training and recruitment utility can provide real-time insights and training during live calls. As discussed above, the sales training and recruitment utility can analyzes salespersons'and customers'dialogue, including identifying and evaluating the effectiveness of answers and rebuttals. Further, the utility can detect and analyze demeanor and professionalism, detects tone, mood, and adherence to professionalism. The utility can detect and analyze tone and disposition via assessing voice tone and overall conversational flow. Further the utility can flags potential areas for improvement and suggest real-time adjustments to enhance call quality and outcomes.

Additional features of the sales training and recruitment utility with an autodialer can include advanced analytics and reporting, post-call analysis, and feedback and recommendations based on the call. The sales training and recruitment utility with an autodialer can tracks key performance indicators (KPIs) including customer sentiment, call success rates, and sales conversion metrics. The sales training and recruitment utility with an autodialer can further provide an easy-to-use interface for managing calls and training sessions including intuitive dashboards displaying real-time and historical performance data, and artificial intelligence prompts configured to guide sales professionals during calls.

The sales training and recruitment utility with an autodialer can further include customizable artificial intelligence training modules configured to allow users to tailor training to their specific sales strategies and goals, and provides scenario-based learning and feedback.

The sales training and recruitment utility with an autodialer can provide enhanced call efficiency via combining predictive dialing with a phone system configured to streamline operations, improved sales performance, and provide real-time artificial intelligence coaching to enhance the effectiveness of sales representatives. Feedback received from users can assist with refining user interactions, boosting user satisfaction and increasing user loyalty. Sales personnel training can be further assisted via use of the sales training and recruitment utility with an autodialer.

The sales training and recruitment utility with an autodialer is configured to optimize performance for sale personnel, improve user communication within their business, and integrate artificial intelligence into communication infrastructures.

The sales training and recruitment utility with an autodialer can be configured to be a standalone system that can be autonomous, for example separate from a call center or a dedicated call service provider. More specifically, the sales training and recruitment utility with an autodialer can be configured to operate on a desktop as a standalone utility and/or can be configured to operate via an application on a mobile device, such as smart phone, tablet, smart watch, or similar devices.

Embodiments can include a system, including a data processing system including a sales training utility configured to provide sales training, the sales training utility can include a graphical user interface, wherein the graphical user interface can include a profile graphical user interface, a record pitch graphical user interface, an explore graphical user interface, and a pitch battle graphical user interface. Embodiments can further include a processing device configured to provide sales training, wherein the processing device can provide sales training via recording pitches, analyzing pitches, conducting pitch battles, and analyzing pitch battles. Embodiments can further include data storage system comprising recorded pitches, scripts for pitches, and industry data. Wherein the sales training utility can be configured to record pitches from a user, process recorded pitch via the processing device and provide analysis of the recorded pitch via the processing device and information stored in the data storage system.

Embodiments can further include the sales training utility configured to generate graphical user interfaces on a smart device selected from the group including televisions, mobile computers, desktop computers, smart cellular phones, smart watches, smart wearables, and combinations thereof.

Embodiments can further include the sales training utility configured to allow the user to record a pitch via a microphone and a camera in a smart device.

Embodiments can further include the sales training utility configured to generate scripts via the processing device and data storage system, and wherein the scripts can be generated based on industry, expert level, or prior pitches.

Embodiments can further include the sales training utility configured to analyze the recorded pitch, and the criteria for analyzing the pitch including tonality, facial expressions, language, or cadence.

Embodiments can further include the recorded pitch being scripted pitch or a freestyle pitch.

Embodiments can further include a method including granting, via a processor, access by a user to a sales training utility, wherein the access can be via a graphical user interface, storing, to a data storage system, data including scripted pitches, industry information, and expert level information, analyzing, by a processor, a recorded pitch, generating the graphical user interface on a client device accessible by the user. Embodiments can further include the graphical user interface including a profile graphical user interface, a record pitch graphical user interface, an explore graphical user interface, and a pitch battle graphical user interface. Embodiments can further include the sales training utility is configured to analyze the recorded pitch employing criteria including tonality, facial expressions, language, or cadence; and executing a pitch analysis via a processing device and a data storage system.

Embodiments can further include enabling, by the processor, a user to recorded pitches by the user and by other users, and enabling, by the processor, a user to provide user analysis of the recorded pitches.

Embodiments can further include enabling, by the processor, a pitch battle, wherein the pitch battle is a live contest between two contestants.

Embodiments can further include enabling, by the processor, users to vote for pitch battle contestants, wherein the voting can include up-votes, down-votes, likes, or comments.

Embodiments can further include providing, by the processor, a bookmark feature allowing the user to save pitch battle for later viewing.

Embodiments can further include providing, by the processor, a share feature allowing the user to share the pitch battle with other users via social media, text messages, email or other electronic systems.

Embodiments can further include the processor processes data including user login information and third-party login information to ensure privacy of the user's real-time information.

Embodiments can further include a sales training utility including a graphical user interface, wherein the graphical user interface can include utilities for displaying a pitch battle in real time, wherein the sales training utility can employ a processor to process data from a data storage system including scripts for pitches, expert level information, and industry information. Embodiment can further include analyzing the pitch battle in real time via a processor, wherein the processor employs criteria including tonality, facial expressions, language, or cadence. Embodiments can further include the graphical user interface further enabling, by the processor, users to vote for pitch battle contestants, wherein the voting can include up-votes, down-votes, likes, or comments.

Embodiments can further include the sales training utility employing artificial intelligence, machine learning and crowd sourcing to analyze the pitch battle.

Embodiments can further include an explore graphical user interface, wherein the explore graphical user interface is configured to input, via a processing device profile data comprising recorded pitches, industry information, expert information, user profiles, and prior activity, and generate, via the processing device and a data storage system, an explore scroll graphical user interface.

Embodiments can further include the explore scroll graphical user interface configured to display, via the data storage system, recoded pitches created for the user by the sale training utility, store, via the data storage system, recorded pitches and pitch battles conducted by the user, and share via social media, text messages, email or other electronic systems the pitch battles or recorded pitches with other users.

Embodiments can further comprise a pitch battle graphical user interface, wherein the pitch battle graphical user interface can be configured to generate, via a processing device, a real-time display of active pitch battles, wherein the pitch battle graphical user interface is further configured to generate, via the processing device and data storage system, real-time interaction with the pitch battles.

Embodiments can further include real-time interactions with the pitch battles including up-votes, down-votes, likes, comment, sharing, and bookmarking.

Embodiment can further include a Debate GUI, similar to the Battle GUI that allows users, such as the salesperson and the customer to debate each other. The voting process can work in a similar manner allowing user to vote for one side via the tools described above.

Embodiments can further include the Sales training and recruitment utility with an autodialer to be configured to make out bound phone calls in which the artificial intelligence can take notes of the phone call and provide a summary and/or dictation after the phone/video call.

Embodiments can include the Sales training and recruitment utility with an autodialer configured to allow user to follow other users by liking, voting or, and/or bookmarking other users.

Embodiment can further include the Sales training and recruitment utility with an autodialer configured to private message other users via the Sales training and recruitment utility with an autodialer.

Embodiments can further include the Sales training and recruitment utility with an autodialer configured to boost a pitch, such as placing the pitch in a higher spot on the explore GUI or other GUI's. This can be done for advertising purposes, as a reward for high votes, or other scores. Boosting a pitch can provide additional exposure to potential recruiters.

Embodiments can further include the Sales training and recruitment utility with an autodialer configured to allow a user, such as a recruiter, to post advertisements in the Sales training and recruitment utility with an autodialer.

Embodiments can further include the Sales training and recruitment utility with an autodialer configured to allow a user, such as a recruiter, to set a daily spend limit for placing advertisements.

Embodiments can further include the Sales training and recruitment utility with an autodialer configured to allow a user, such as a recruiter wherein the ad can be shown in specific geographic areas, at specific times, to certain user based on their profile information, and/or to specific business, industry, and expertise level users.

Embodiments can further include the Sales training and recruitment utility with an autodialer configured to allow a user to battle or debate an artificial intelligence generated contestant, such as a salesperson, a customer, or a debater. The artificial intelligence generated contestant can be configured to provide arguments, rebuttals, read scripts, or act in a fluid manner responding to the user.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A system, comprising:
a data processing system comprising:
a sales training utility configured to provide sales training, the sales training utility comprising:
a graphical user interface,
wherein the graphical user interface comprises: a profile graphical user interface, a record pitch graphical user interface, an explore graphical user interface, and a pitch battle graphical user interface,
a processing device configured to provide sales training,
wherein the processing device provides sales training via: recording pitches, analyzing pitches, conducting pitch battles, and analyzing pitch battles,
a data storage system comprising:
recorded pitches,
scripts for pitches, and
industry data,
an autodialer,
wherein the autodialer is configured to autodial telephone calls via the sales training utility;
wherein the sales training utility is configured to record pitches from a user, process recorded pitch via the processing device and provide analysis of the recorded pitch via the processing device and information stored in the data storage system.

2. The system of claim 1, wherein:
the sales training utility is configured to generate graphical user interfaces on a smart device selected from the group including televisions, mobile computers, desktop computers, smart cellular phones, smart watches, smart wearables, and combinations thereof.

3. The system of claim 1, wherein:
the sales training utility is configured to allow the user to record a pitch via a microphone and a camera in a smart device.

4. The system of claim 1, wherein:
the sales training utility is configured to generate scripts via the processing device and data storage system, and wherein the scripts can be generated based on:
an industry,
an expert level, or
prior pitches.

5. The system of claim 4, wherein:
the sales training utility is configured to analyze the recorded pitch, via analysis of criteria comprising:
tonality,
facial expressions,
language, or
cadence.

6. The system of claim 1, wherein:
the recorded pitch comprises:
a scripted pitch.

7. The system of claim 1, wherein:
the recorded pitch comprises:
a freestyle pitch.

8. A method comprising:
granting, via a processor, access by a user to a sales training utility;
wherein the access is via a graphical user interface,
storing, to a data storage system, data comprising:
scripted pitches,
industry information,
expert level information, and
telephone numbers,
calling a telephone number via an autodialer,
analyzing, by a processor, a recorded pitch,
generating the graphical user interface on a client device accessible by the user,
wherein the graphical user interface comprises:
a profile graphical user interface,
a record pitch graphical user interface,
an explore graphical user interface, and
a pitch battle graphical user interface,
wherein the sales training utility is configured to:
analyze the recorded pitch employing criteria comprising:
tonality,
facial expressions,
language, or
cadence; and
executing a pitch analysis via a processing device and a data storage system.

9. The method of claim 8, further comprising:
enabling, by the processor, a user to record pitches by the user and by other users, and
enabling, by the processor, a user to provide user analysis of the recorded pitches.

10. The method of claim 9, further comprising:
enabling, by the processor, a pitch battle,
wherein the pitch battle is a live contest between two contestants.

11. The method of claim 10, further comprising:
enabling, by the processor, users to vote for pitch battle contestants,
wherein the voting can comprise:
up-votes,
down-votes,
likes, or
comments.

12. The method of claim 10, further comprising:
providing, by the processor, a bookmark feature allowing the user to save pitch battle for later viewing.

13. The method of claim 10, further comprising:
providing, by the processor, a share feature allowing the user to share the pitch battle with other users via social media, text messages, email or other electronic systems.

14. The method of claim 8, wherein:
the processor processes data comprising user login information and third-party login information to ensure privacy of a user's real-time information.

15. A system comprising:
a sales training utility comprising a graphical user interface,
wherein the graphical user interface comprises utilities for displaying a pitch battle in real time,
wherein the sales training utility employs a processor to process data from a data storage system comprising:
scripts for pitches,
expert level information, and
industry information,
analyzing the pitch battle in real time via a processor, wherein the processor employs criteria comprising:
tonality,
facial expressions,
language, or
cadence; and
the graphical user interface further enabling, by the processor, users to vote for pitch battle contestants,
wherein the voting comprises:
up-votes,
down-votes,
likes, or
comments.

16. The system of claim 15, wherein:
the sales training utility employs artificial intelligence, machine learning and crowd sourcing to analyze the pitch battle.

17. The system of claim 16,
comprising an explore graphical user interface, wherein the explore graphical user interface is configured to:
input, via a processing device profile data comprising:
recorded pitches,
industry information,
expert information,
user profiles, and
prior activity, and
generate, via the processing device and a data storage system, an explore scroll graphical user interface.

18. The system of claim 17,
wherein the explore scroll graphical user interface is configured to:
display, via the data storage system, recoded pitches created for the user by the sale training utility,
store, via the data storage system, recorded pitches and pitch battles conducted by the user, and
share via social media, text messages, email or other electronic systems the pitch battles or recorded pitches with other users.

19. The system of claim 18,
comprising a pitch battle graphical user interface, wherein the pitch battle graphical user interface is configured to:
generate, via a processing device, a real-time display of active pitch battles,
wherein the pitch battle graphical user interface is further configured to generate, via the processing device and data storage system, real-time interaction with the pitch battles.

20. The system of claim 15,
further comprising an autodialer,
wherein the autodialer is configured to:
select a telephone number from a database associated with the autodialer,
dial a telephone number via the autodialer,
rout a telephone call through the sales training and recruitment utility, provide scripts, suggestions, and questions to a user via the sales training and recruitment utility, and
record the telephone call and provide analysis of the call via the sales training and recruitment utility.
